(19) United States
(12) Patent Application Publication
(10) Pub. No.: US 2013/0257735 A1
(43) Pub. Date: Oct. 3, 2013

(54) Electronic Devices Having Multiple Keypads and Related Methods

(71) Applicant: Idris Omerovic, Lund (SE)

(72) Inventor: Idris Omerovic, Lund (SE)

(21) Appl. No.: 13/498,191

(22) PCT Filed: Dec. 17, 2010
(86) PCT No.: PCT/IB10/03295

§ 371 Date: Sep. 18, 2012

(51) Int. Cl. G06F 3/02

(52) U.S. Cl. CPC G06F 3/0202
USPC 345/168

(57) ABSTRACT

An electronic device includes an upper display unit and a lower keypad unit. The display unit has a display screen thereon. The display unit has first and second opposed side edges. The keypad unit has a first region and a second region and includes a first keypad on the first region and a second keypad on the second region. The keypad unit is slidably connected to the display unit on a side opposite the display screen. The keypad unit is movable relative to the display unit along a slide axis between: a closed position in which the display unit generally overlies the first keypad and the second keypad; a first open position in which the first keypad is exposed and positioned adjacent the first side edge of the display unit; and a second open position in which the second keypad is exposed and positioned adjacent the second side edge of the display unit.

### FIELD OF THE INVENTION

The present invention relates to electronic devices, and in particular, to mobile devices having multiple keypads for different modes of operation and related methods.

### BACKGROUND

Handheld communication devices typically include various functionalities integrated into a single unit. A single handheld device may provide Internet access, web-browsing, video and/or music playing, text display, gaming and other functions in addition to cellular communications.

Size constraints may be considerable on mobile devices that are configured as multipurpose, integrated handheld devices. Touch sensitive screens may provide increased flexibility for functionality such as web-browsing, telephone operation, text, gaming video/music playing, etc. However, users may prefer traditional keypads having press-buttons for some operations, such as text operations or video game controls. In some handheld devices, a separate text keypad is positioned adjacent a touch display, for example, such as a QWERTY keypad for entering text for display on a screen. Such keypad/screen arrangements may be in slidable or clamshell configurations.

### SUMMARY OF EMBODIMENTS OF THE INVENTION

According to embodiments of the present invention, an electronic device includes an upper display unit and a lower keypad unit. The display unit has a display screen thereon. The display unit has first and second opposed side edges. The keypad unit has a first region and a second region and includes a first keypad on the first region and a second keypad on the second region. The keypad unit is slidably connected to the display unit on a side opposite the display screen. The keypad unit is movable relative to the display unit along a slide axis between: a closed position in which the display unit generally overlies the first keypad and the second keypad; a first open position in which the first keypad is exposed and positioned adjacent the first side edge of the display unit; and a second open position in which the second keypad is exposed and positioned adjacent the second side edge of the display unit.

In some embodiments, the display unit generally overlies the second keypad when the keypad unit is in the first open position, and the display unit generally overlies the first keypad when the keypad unit is in the second open position.

The first keypad may include a set of control keys configured for controlling a video game. The second keypad may include a set of keys configured for entering text into the device. In some embodiments, the second keypad is a QWERTY keypad.

According to some embodiments, the device includes a coupling system including: a rail slot defined in one of the display unit and the keypad unit, the rail slot having first and second enlarged sections and a narrow section connecting the first and second enlarged sections; and a guide post affixed to the other of the display unit and the keypad unit, the guide post including a head, the head having an outwardly biased latch member. The guide post is slidably mounted in the rail slot such that the head is compressed when in the narrow section and expands when in the first or second enlarged section to thereby retain the keypad unit in the first or second open position.

In some embodiments, the device includes a flexible connector extending from the display unit to the keypad unit to provide a conduit for power and/or data transmission between the display unit and the keypad unit. The flexible connector may include a flexible printed circuit including at least one bend and at least one reserve section to accommodate movement of the keypad unit into each of the first and second open positions.

According to some embodiments, the device includes a first wireless transmitter in the display unit and a second wireless transmitter in the keypad unit to enable data communications between the display unit and the keypad unit.

In some embodiments, the keypad unit is tilted at a tilt angle with respect to the display screen when the keypad unit is in at least one of the first and second open positions. The keypad unit may be tilted at a tilt angle with respect to the display screen when the keypad unit is in each of the first and second open positions. The device can include a frame, wherein the keypad unit is slidably mounted in the frame, and the frame retains the first keypad in a non-tilted orientation with respect to the display screen when the keypad unit is withdrawn from the frame a first distance and permits the first keypad to attain a tilted orientation with respect to the display screen when the keypad unit it withdrawn from the frame a second distance. In some embodiments, the first and second keypads are pivotally coupled to one another, and the first keypad, when withdrawn from the frame the second distance, attains the tilted orientation with respect to the display screen by pivoting with respect to the second keypad. The device may include a spring configured to bias the first keypad to pivot with respect to the second keypad into the tilted orientation. In some embodiments, the spring is an elastomeric spring.

According to method embodiments of the present invention, a method of operating an electronic device includes providing an electronic device including: an upper display unit having a display screen thereon, the display unit having first and second opposed side edges; and a lower keypad unit having a first region and a second region and including a first keypad on the first region and a second keypad on the second region. The keypad unit is slidably connected to the display unit on a side opposite the display screen, the keypad unit being movable relative to the display unit along a slide axis between: a closed position in which the display unit generally overlies the first keypad and the second keypad; a first open position in which the first keypad is exposed and positioned adjacent the first side edge of the display unit; and a second open position in which the second keypad is exposed and positioned adjacent the second side edge of the display unit. The method further includes: moving the keypad unit to the first open position such that the first keypad extends beyond the display unit and is generally accessible to the user to operate the device in a first mode of operation using the first keypad; and moving the keypad unit to the second open position such that the second keypad extends beyond the display unit and is generally accessible to the user to operate the device in a second mode of operation using the second keypad.

According to some embodiments, moving the keypad unit to the first open position includes sliding the keypad unit in a first direction along the slide axis and moving the keypad unit to the second open position includes sliding the keypad unit in a second direction along the slide axis that is opposite the first direction.

According to embodiments of the present invention, an electronic device includes a display unit and a keypad unit. The display unit includes a display screen thereon and a frame. The display unit has a side edge. The keypad unit includes a base member and a keypad on the base member. The keypad unit is slidably mounted in the frame and movable along a slide axis between a closed position in which the display unit generally overlies the keypad and an open position in which the keypad is exposed and positioned adjacent the side edge of the display unit. The frame retains the keypad in a non-tilted orientation with respect to the display screen when the keypad unit is withdrawn from the frame a first distance and permits the keypad to attain a tilted orientation with respect to the display screen when the keypad unit it withdrawn from the frame a second distance.

In some embodiments, the keypad unit includes first and second base members pivotally coupled to one another, the keypad is disposed on the first base member, and the keypad, when withdrawn from the frame the second distance, attains the tilted orientation with respect to the display screen by pivoting with respect to the second base member. The device may include a spring configured to bias the first base member to pivot with respect to the second base member into the tilted orientation. In some embodiments, the spring is an elastomeric spring.

Further features, advantages and details of the present invention will be appreciated by those of ordinary skill in the art from a reading of the figures and the detailed description of the embodiments that follow, such description being merely illustrative of the present invention.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a top plan view of a mobile terminal according to embodiments of the present invention in a closed position.

FIG. 2 is a top plan view of the mobile terminal of FIG. 1 in a first open position.

FIG. 3 is a top plan view of the mobile terminal of FIG. 1 in a second open position.

FIG. 4 is a schematic bottom end view of the mobile terminal of FIG. 1 in the closed position.

FIG. 5 is a schematic bottom end view of the mobile terminal of FIG. 1 in the first open position.

FIG. 6 is a schematic bottom end view of the mobile terminal of FIG. 1 in the second open position.

FIG. 7 is an exploded, top plan view of the mobile terminal of FIG. 1.

FIG. 8 is a schematic diagram of the mobile terminal of FIG. 1 and an exemplary base station transceiver.

FIG. 9 is side view of the mobile terminal of FIG. 1 illustrating a slidable coupling system according to embodiments of the present invention.

FIG. 10 is a bottom plan view of a display unit of the mobile terminal of FIG. 1.

FIG. 11 is top plan view of a keypad unit of the mobile terminal of FIG. 1.

FIG. 12 is side view of the keypad unit of FIG. 11.

FIG. 13 is an enlarged, fragmentary bottom view of the display unit of FIG. 10.

FIG. 14 is a fragmentary, cross-sectional, side view of a mobile terminal according to further embodiments of the present invention in a closed position.

FIG. 15 is a fragmentary, cross-sectional, side view of the mobile terminal of FIG. 14 in a first open position.

FIG. 16 is a fragmentary, cross-sectional, side view of the mobile terminal of FIG. 14 in a second open position.

FIG. 17 is a fragmentary, cross-sectional, side view of the mobile terminal of FIG. 14 in an alternative second open position.

FIG. 18 is a top plan view of a mobile terminal according to further embodiments of the present invention in a closed position.

FIG. 19 is a bottom end view of the mobile terminal of FIG. 18 in the closed position.

FIG. 20 is a side view of the mobile terminal of FIG. 18 in the closed position.

FIG. 21 is a cross-sectional, perspective view of the mobile terminal of FIG. 18 in the closed position, taken along the line 21-21 of FIG. 18.

FIG. 22 is a fragmentary, bottom perspective view of the mobile terminal of FIG. 18 in the closed position.

FIG. 23 is a cross-sectional view of the mobile terminal of FIG. 18 in the closed position, taken along the line 21-21 of FIG. 18.

FIG. 24 is a cross-sectional view of the mobile terminal of FIG. 18 in a non-tilted first open position, taken along the line 21-21 of FIG. 18.

FIG. 25 is a cross-sectional view of the mobile terminal of FIG. 18 in a second open position, taken along the line 21-21 of FIG. 18.

FIG. 26 is a top perspective view of the mobile terminal of FIG. 18 in the second open position.

FIG. 27 is a top perspective view of the mobile terminal of FIG. 18 in the non-tilted first open position.

FIG. 28 is a top perspective view of the mobile terminal of FIG. 18 in a tilted first open position.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

As used herein, a “communication terminal” includes, but is not limited to, a terminal that is configured to receive/transmit communication signals via a wireline connection, such as via a public-switched telephone network (PSTN), digital subscriber line (DSL), digital cable, or another data connection/network, and/or via a wireless interface with, for example, a cellular network, a satellite network, a wireless local area network (WLAN), and/or another communication terminal.

When the communication terminal is configured to communicate over a wireless interface, it is referred to herein as a “wireless communication terminal” or a “wireless terminal.” Examples of wireless terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

As used herein, “mobile terminal” refers to a terminal that is portable or transportable by a user without the aid of a vehicle or the like.

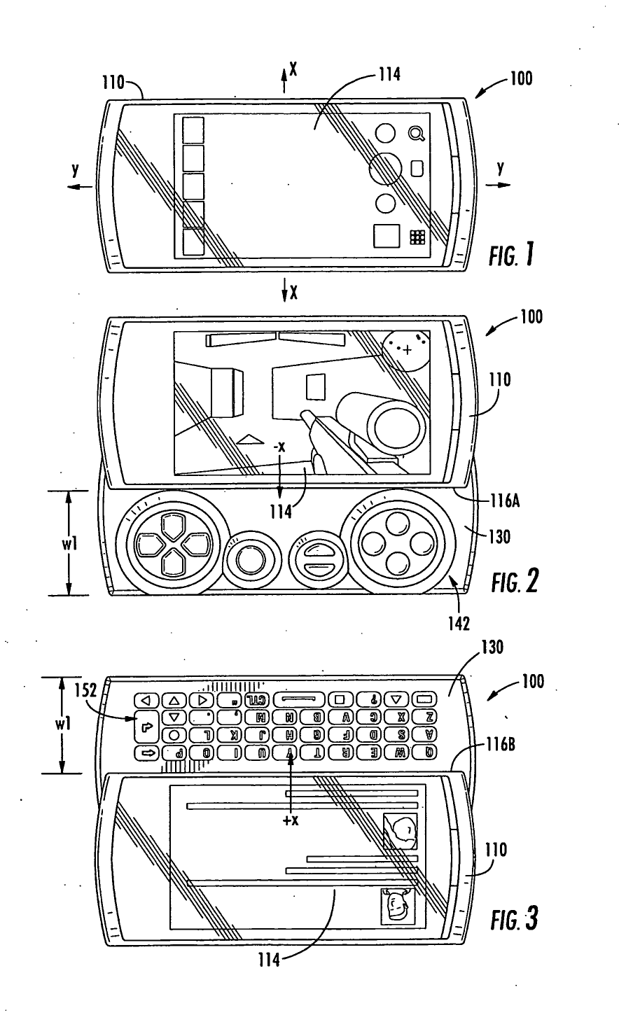

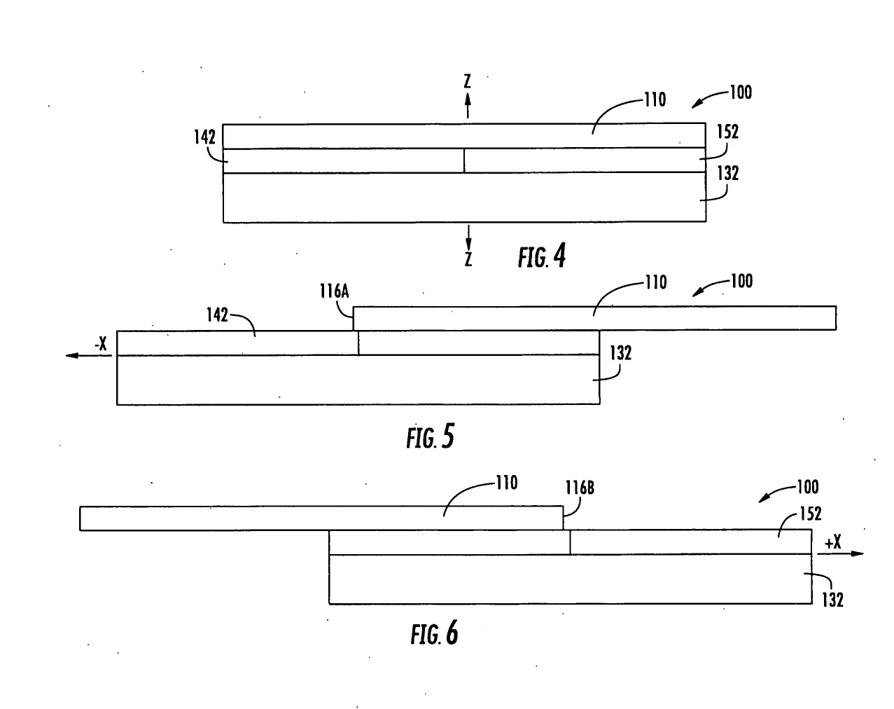

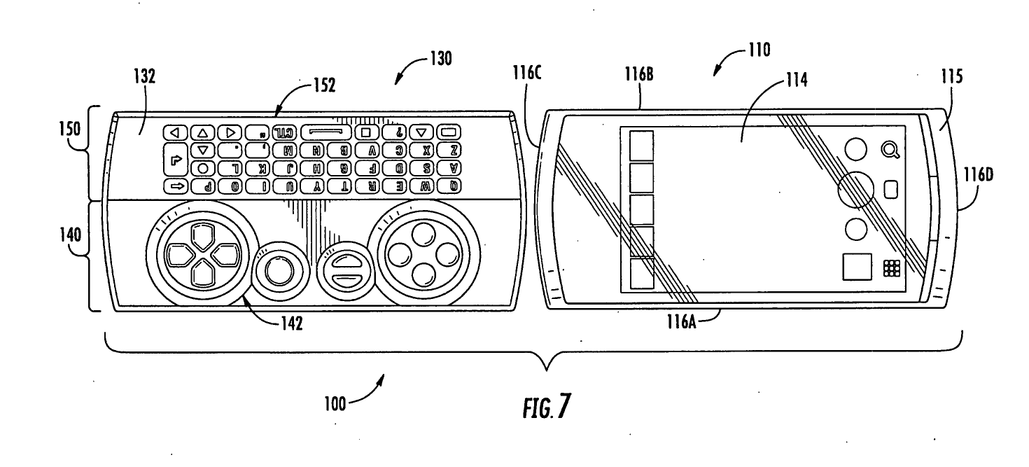

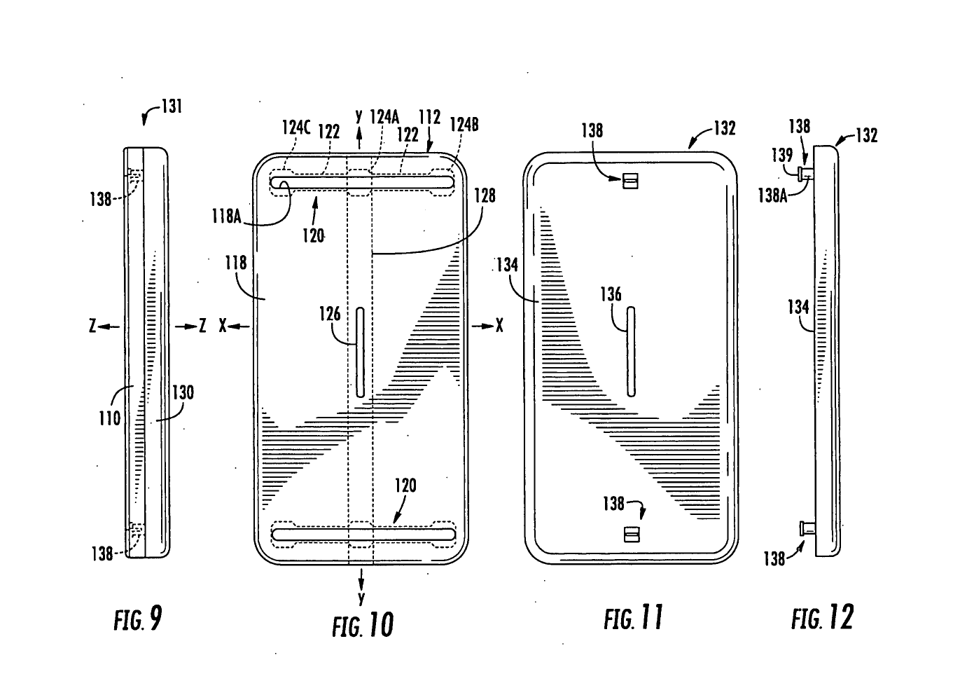

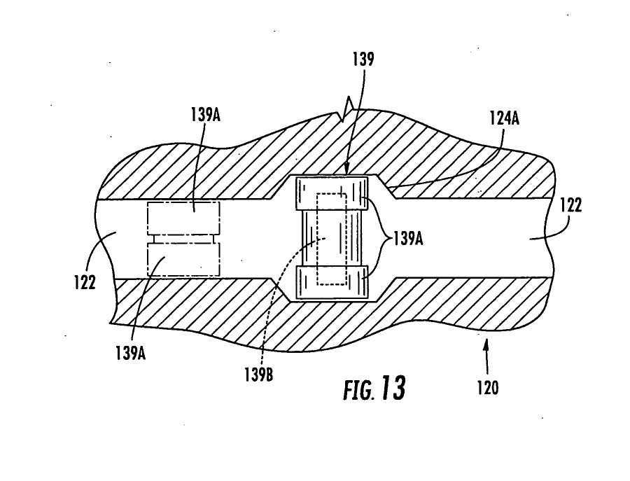

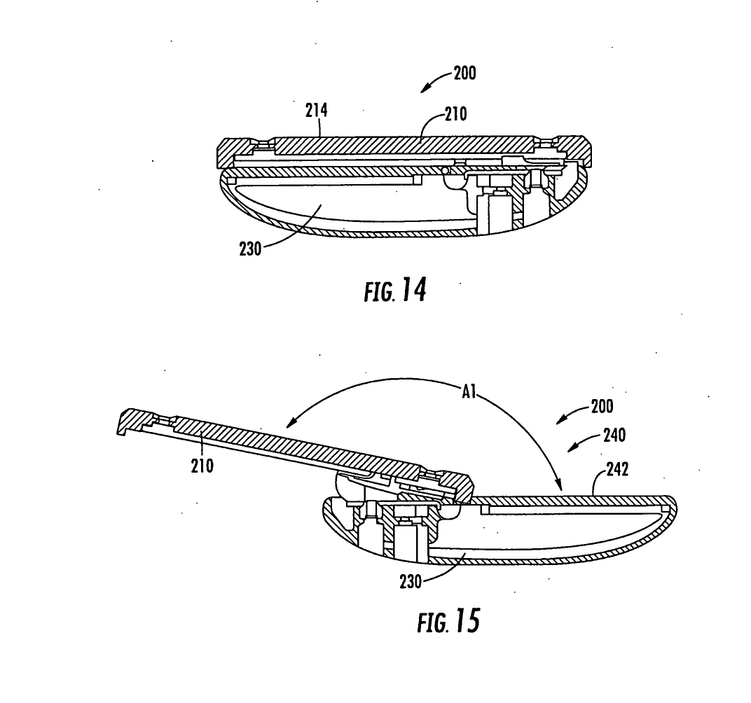

With reference to FIGS. 1-13, a mobile terminal 100 according to embodiments of the present invention is shown therein. The mobile terminal 100 includes an upper display unit 110 and a lower keypad unit 130. The mobile terminal 100 has a main or lengthwise axis Y-Y (FIG. 1), a lateral or slide axis X-X, and a heightwise axis Z-Z (FIG. 4). As described below, the mobile terminal 100 includes a first or gaming keypad 142 and a second or QWERTY keypad 152 and can be manipulated to alternately expose each of the keypads 142 and 152 for access and use by an operator (FIGS. 2 and 3). Moreover, the keypads 142 and 152 can be simultaneously stored beneath the display unit 110 (FIG. 1).

According to some embodiments, the mobile terminal 100 is a mobile wireless communication terminal. Referring now to FIG. 8, an exemplary mobile wireless communication terminal 100 in accordance with some embodiments of the present invention is illustrated. The wireless terminal 100 is configured to communicate data with one or more other wireless terminals over a direct wireless communication interface therebetween, over another wireless communication interface through one or more cellular base stations, and/or over another wireless communication interface through a wireless local area network (WLAN) router.

The wireless terminal 100 may be a mobile radiotelephone forming a part of a radiotelephone communication system 2 as illustrated in FIG. 8. The system 2 includes the mobile wireless communication terminal 100 and a base station transceiver, which is part of a wireless communications network 5. In some embodiments of the present invention, the network 5 includes a base station transceiver that includes the radio transceiver(s) that define an individual cell in a cellular network and communicates with the mobile terminal 100 (via an interface 7) and other mobile terminals in the cell using a radio-link protocol. It will be understood that, in some embodiments of the present invention, many base station transceivers may be connected through, for example, a mobile switching center and other devices to define the wireless communications network 5.

The mobile terminal 100 in the illustrated embodiments includes a portable housing assembly 12, a user interface 22 (i.e., a man machine interface (MMI)), a controller 30, a communication module 32, and a memory 34. The foregoing components of the mobile terminal 100 may be included in many conventional mobile terminals and their functionality is generally known to those skilled in the art.

The user interface 22 may include any suitable input device(s) including, for example, a display screen 114, a speaker, a touch activated or touch sensitive device (e.g., a touch screen) 117, a joystick, a keyboard/keypad, a dial, a directional key or keys, a pointing device (such as a mouse, trackball, touch pad, etc.), a speaker that generates sound responsive to an input audio signal, and/or a microphone coupled to an audio processor that is configured to generate an audio data stream responsive to sound incident on the microphone. The user interface 22 further includes the first keypad 142 and the second keypad 152 as described herein.

The display screen 114 may be any suitable display screen assembly. For example, the display screen 114 may be a liquid crystal display (LCD) with or without auxiliary lighting (e.g., a lighting panel).

The controller 30 may support various functions of the mobile terminal 100. The controller 30 can be any commercially available or custom microprocessor, for example. In use, the controller 30 of the mobile terminal 100 generates a display image on the display 114 and receives input signals from the keypads 142, 152 and the touchscreen 117. The controller 30 may control various other components of the mobile terminal 100.

The memory 34 is configured to store digital information signals and data such as game applications, word processing applications, digital audio files, digital video files, etc.

The communication module 32 may be configured to communicate data over one or more wireless interfaces (e.g., wireless interface 7) to another remote wireless terminal as discussed herein. The communication module 32 can include a cellular communication module, a direct point-to-point connection module, and/or a WLAN module.

With a cellular communication module, the wireless terminal 100 can communicate via the base station(s) of the network 5 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

A direct point-to-point connection module may include a direct RF communication module or a direct IR communication module. The direct RF communication module may include a Bluetooth module. With a Bluetooth module, the wireless terminal 100 can communicate via an ad-hoc network through a direct point-to-point interface.

With a WLAN module, the wireless terminal 100 can communicate through a WLAN using a communication protocol that may include, but is not limited to, 802.11a, 802.11b, 802.11e, 802.11g, 802.11i, and/or 802.11n.

The communication module 32 can include a transceiver typically having a transmitter circuit and a receiver circuit, which respectively transmit outgoing radio frequency signals (e.g., to the network 5, a router or directly to another terminal) and receive incoming radio frequency signals (e.g., from the network 5, a router or directly to another terminal), such as voice and data signals, via an antenna. The communication module 32 may include a short range transmitter and receiver, such as a Bluetooth transmitter and receiver. The antenna may be an embedded antenna, a retractable antenna or any antenna known to those having skill in the art without departing from the scope of the present invention. The radio frequency signals transmitted between the mobile terminal 100 and the network 5, router or other terminal may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver may include an infrared (IR) transceiver configured to transmit/receive infrared signals to/from other electronic devices via an IR port.

The mobile terminal 100 may also be configured to electrically couple with another terminal via a wireline or cable for the transmission of digital communication signals therebetween. The mobile terminal 100 may include further components such as a camera device configured to generate a still image and/or video data stream based on incident light.

According to some embodiments, the mobile terminal 100 is a handheld (portable) mobile terminal. By “handheld mobile terminal,” it is meant that the outer dimensions of the mobile terminal are adapted and suitable for use by a typical operator using one hand. According to some embodiments, the total volume of the handheld mobile terminal is less than about 200 cc. According to some embodiments, the total volume of the handheld terminal is less than about 100 cc. According to some embodiments, the total volume of the handheld mobile terminal is between about 50 and 100 cc. According to some embodiments, no dimension of the handheld mobile terminal 100 exceeds about 200 mm.

With reference to FIGS. 1-3 and 7, the display unit 110 includes a case or body 115 having a first or left side edge 116A, a second or right side edge 116B (opposite and spaced apart from the left side edge 116A along the axis X-X), a third or top edge 116C, and a fourth or bottom edge 116D (opposite and spaced apart from the top edge 116C along the axis Y-Y). The display screen 114 is mounted on the body 115.

The keypad unit 130 includes a case or body 132 defining a first region 140 and a second region 150. A first or gaming keypad 142 is disposed on the first region 140. A second or text entry keypad 152 disposed on the second region 150. The text entry keypad 152 may be referred to herein as a QWERTY keypad; however, other configurations of keys may be provided.

The keypad unit 130 is slidably coupled to the display unit 110 on a side opposite the display screen 114 for sliding movement in each of a first direction −X (which may be referred to herein as a leftward direction) and a second direction +X (which may be referred to herein as a rightward direction) along the slide axis X-X.

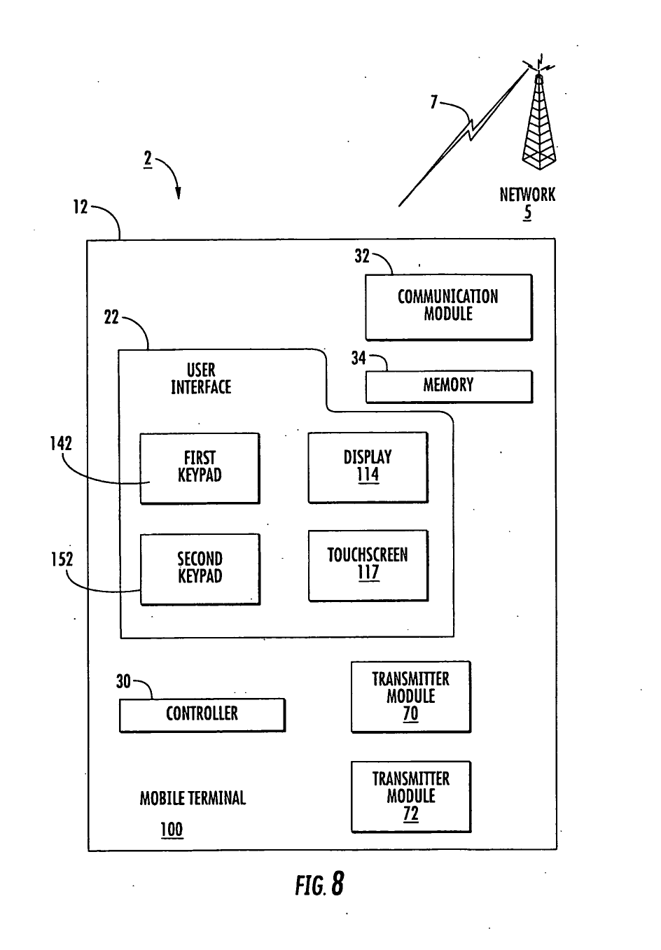

As illustrated in FIGS. 1-6, the keypad unit 130 is movable (e.g., by pushing or pulling) between a closed position (as shown in FIGS. 1 and 4), a first open position (as shown in FIGS. 2 and 5), and a second open position (as shown in FIGS. 3 and 6). While the movement of the mobile terminal 100 is described herein in terms of sliding the keypad unit 130 with respect to the display unit 110, it will be appreciated that such movement can likewise be described in terms of or effected by sliding the display unit 110 with respect to the keypad unit 130.

With the keypad unit 130 in the closed position (FIGS. 1 and 4), the user can slide the keypad unit 130 in the −X direction to the first open position (FIGS. 2 and 5) so that the region 140 extends laterally beyond the side edge 116A and the game keypad 142 is exposed and disposed adjacent the side edge 116A. Alternatively, with the keypad unit 130 in the closed position, the user can slide the keypad unit 130 in the +X direction (opposite the first direction −X) to the second open position (FIGS. 3 and 6) so that the region 150 extends laterally beyond the side edge 116B and the QWERTY keypad 152 is exposed and disposed adjacent the side edge 116B. The keypad unit 130 can be returned to the closed position from either of the open positions by sliding the keypad unit 130 in the direction opposite of the deploying direction.

According to some embodiments, the second keypad 152 is substantially entirely covered by the display unit 110 when the terminal 100 is in the first open position, the first keypad 142 is substantially entirely covered by the display unit 110 when the terminal 100 is in the second open position, and both of the keypads 142, 152 are substantially entirely covered by the display unit 110 when the terminal 100 is in the closed position.

According to some embodiments, the display screen 114 defines a display plane and the slide axis X-X is substantially parallel to the display plane. In some cases, the keypads 142, 152 are oriented such that they each lie in or define a keypad plane substantially parallel to the display plane.

Thus, the user of the terminal 100 is able to use either the gaming keypad 142 or the QWERTY keypad 152 while viewing the display screen 114. In some embodiments, the display 114 is a touch sensitive display that may be used as another user interface. Accordingly, the terminal 100 may be operated in at least three different modes. As illustrated in FIG. 1, the user may enter commands on the display screen 114 in a touch sensitive display mode (e.g., for internet viewing, reading text, viewing videos and the like). When the keypad unit 130 is moved to the first open position as illustrated in FIG. 2, the user may operate the exposed gaming keypad 142 to use the terminal 100 in a gaming mode. When the keypad unit 130 is moved to the second open position as illustrated in FIG. 3, the user may operate the QWERTY keypad 152 and use the terminal 100 in a texting or typing mode. In some embodiments, the terminal 100 is configured to automatically switch a mode of operation responsive to the keypad that is accessible to the user. For example, the mobile terminal 100 automatically switches to a touch screen mode when the keypad unit 130 is in the position illustrated in FIG. 1, a gaming mode in the position illustrated in FIG. 2, and a text mode in the position illustrated in FIG. 3. As part of the automatic mode switching, the terminal 100 may switch the orientation of the image displayed on the display screen 114 to properly address a user viewing the terminal 100 from the side of the display unit 110 having the exposed keypad 142, 152.

Moreover, it should be understood that, although embodiments according to the invention are illustrated with respect to a gaming keypad 142 and a QWERTY keypad 152, any suitable configuration of keys may be used, including a numeric keypad, a touchpad, a touch sensitive display or other user input keys known to those of skill in the art.

The display unit 110 and the keypad unit 130 may be electrically connected to one another and/or to a common processor (e.g., the controller 30) to allow user inputs on the touch screen 117 or on the keypads 142, 152 to be received as inputs to the device. In some embodiments, wired electrical connections, such as flexible printed circuit boards, fiber optics or other electrical connectors that enable communications between the display unit and the keypad unit may be used.

In some embodiments, the units 110, 130 can be wirelessly connected to one another or a common processor resident on the mobile terminal 100. For this purpose, the units 110 and 130 may each include a respective transmitter module 70, 72 (FIG. 8) operative to wirelessly transmit and receive communications data (for example, to/from one another). For example, the transmitter modules 70, 72 may communicate using the Wi-Fi Direct or other suitable standard.

With reference to FIGS. 9-13, a coupling system 131 according to embodiments of the present invention for slidably joining the display unit 110 and the keypad unit 130 is shown therein. The coupling system 131 includes a pair of opposed guide rail slots 120 formed in a rear wall 118 of the case 112, a pair of guide posts 138 extending upwardly from a front wall 134 of the case 132, an electrical connector slot 126 defined in the rear wall 118, and an electrical connector slot 136 defined in the front wall 134.

The guide rails 120 are spaced apart along the Y-Y axis adjacent the top and bottom edges 116C, 116D, for example, and extend generally parallel to the slide axis X-X. Each rail 120 includes three enlarged sections 124A, 124B, 124C separated by narrow sections 122.

Each guide post 138 includes a shaft 138A and a head 139 comprised of a pair of opposed latch members 139A biased outwardly in opposed directions generally parallel to the axis Y-Y by a spring 139B. Each guide post 138 is slidably disposed in a respective one of the rails 120 as shown in FIGS. 9 and 13. The widths of the slots 118A overlying the rail slots 120 may be less than the compressed widths of the heads 139 so that the guide posts 138 are restricted from movement in the Z-Z axis direction and thereby captured in the rail slots 120.

When the terminal 100 is in the closed position, the guide posts 138 will reside in the enlarged sections 124A. When the terminal 100 is in the first open position, the guide posts 138 will reside in the enlarged sections 124B. When the terminal 100 is in the second open position, the guide posts 138 will reside in the enlarged sections 124C. As illustrated in FIG. 13, in order to transition the terminal from one position to another, the user must apply sufficient push or pull force along the slide axis X-X to overcome the bias of the springs 139B and compress the latch members 139A into the narrow section 122 between the enlarged section 124A-C of the current position and the enlarged section 124A-C of the target position. When the terminal 100 attains the new position, the latch members 139A will re-expand into the associated enlarged section under the force of the springs 139B, providing a positive lock and tactile feedback. According to some embodiments, the coupling system 131 is configured such that the heads 139 will generate an audible sound (e.g., a click noise) to provide an audible indication that the desired new position has been achieved.

An electrical connector can be routed between the units 110, 130 through the slots 126, 136. Suitable connectors may include coax, fiber optic or FPC connectors.

According to some embodiments, the coupling system 131 provides a “dead zone” 128 on the rear wall 118 that is the area of the display unit 110 that is underlapped by the keypad unit 130 in both the first open position and the second open position.

According to some embodiments, the width W1 of the portion of each keypad 142, 152 extending beyond the respective side edge 116A, 116B when the keypad 142, 152 is exposed is at least 46% of the width of the display unit 110 and, according to some embodiments, between about 46.5% and 48% of the width of the display unit 110.

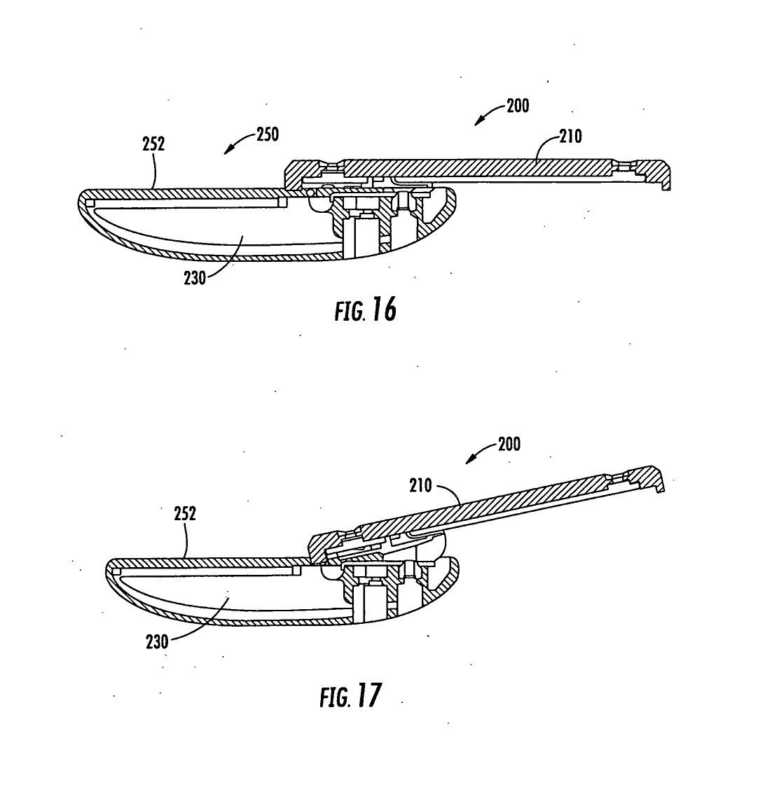

With reference to FIGS. 14-17, a mobile terminal 200 according to further embodiments of the present invention is shown therein. The terminal 200 includes a display unit 210 and a keypad unit 230 slidably coupled to the display unit 210. The display unit 210 includes a display screen 214. The keypad unit 230 has a first region 240 on which a first (e.g., gaming) keypad 242 is mounted and a second region 250 on which a second (e.g., text entry) keypad 252 is mounted. The terminal 200 may generally correspond to and be operated in the same manner as the terminal 100 to assume a closed position (as shown in FIG. 14), a first open position (as shown in FIG. 15), and a second open position (as shown in FIG. 16), except that the terminal 200 is also configured to tilt the display unit 210 with respect to the keypad unit 230 when in the first open position as shown in FIG. 15. The terminal 200 may be configured to orient the display unit 210 flat (i.e., at a substantially zero degree angle) with respect to the keypad unit 230 when in the second open position as shown in FIG. 16 or, alternatively, may be configured to also tilt the display unit 210 with respect to the keypad unit 230 when in the second open position as shown in FIG. 17. According to some embodiments, the angle of tilt A1 (FIG. 15) is in the range of from about 90 to 180 degrees, according to some embodiments, between about 90 and 170 degrees, and, according to some embodiments between about 150 and 160 degrees.

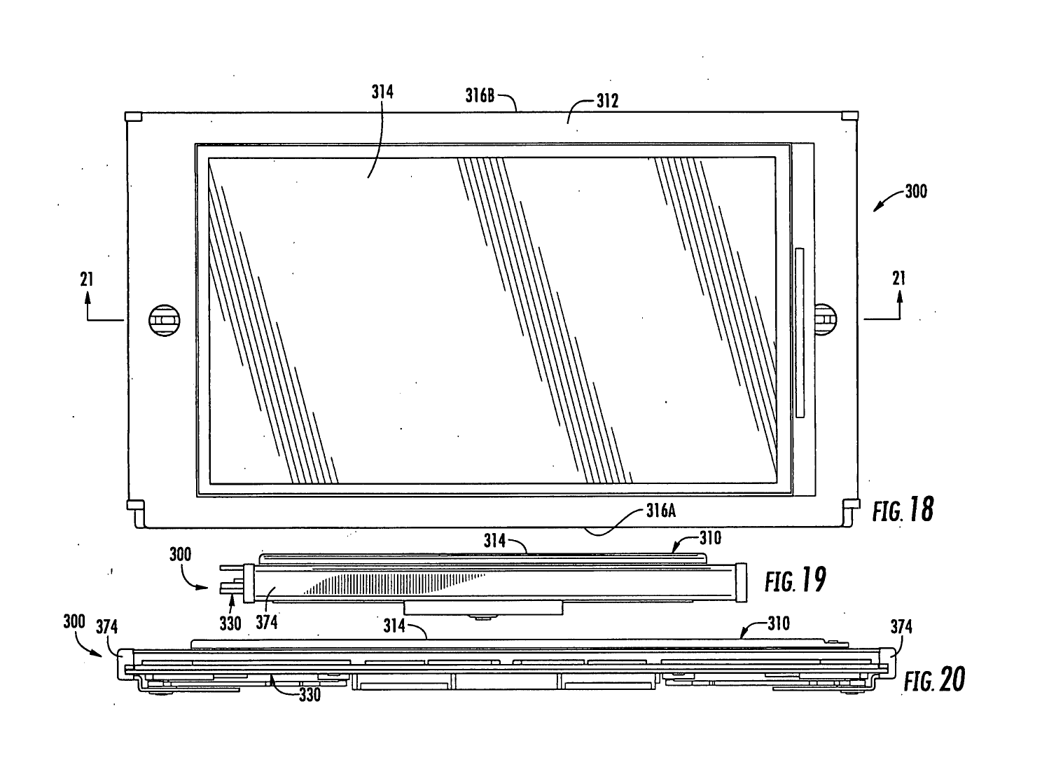

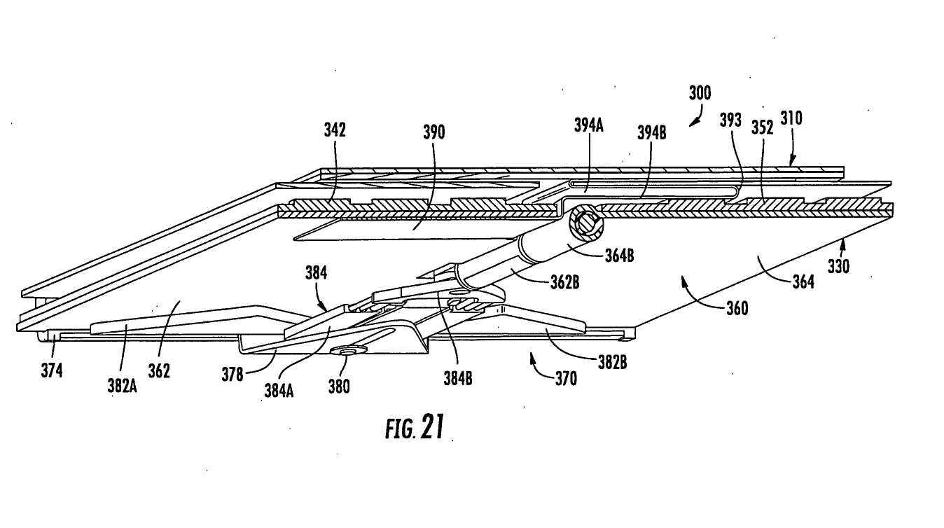

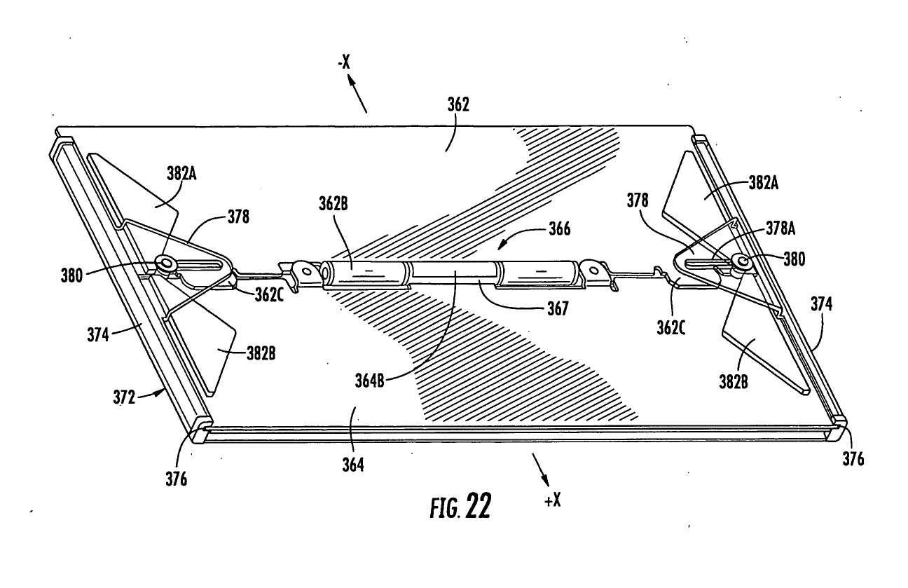

With reference to FIGS. 18-28, a mobile terminal 300 according to further embodiments of the present invention is shown therein. The terminal 300 includes a display unit 310, a keypad unit 330, and a coupling system 370. As described below, the terminal 300 can provide a tilt angle between the display unit 310 and the keypad unit 330 when the keypad unit 330 is deployed.

The display unit 310 includes a body or case 312 and a display screen 314 mounted thereon. The case 312 has a first or left side edge 316A and an opposed second or right side edge 316B.

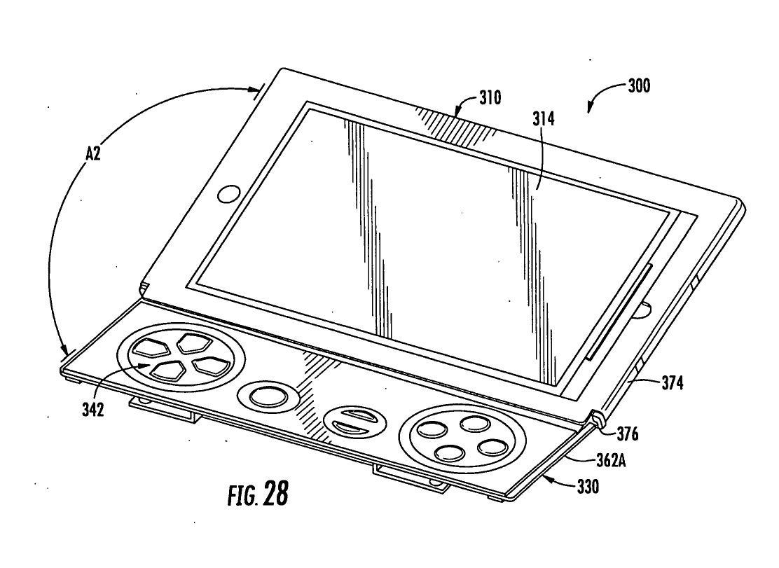

The keypad unit 330 includes a base plate assembly 360. The base plate assembly 360 includes a first base member or base plate 362 and a second base member or base plate 364. The first base plate 362 has opposed edge portions 362A (FIG. 27) and the second base plate 364 has opposed edge portions 364A (FIG. 26). The first base plate 362 has a hinge feature 362B and the second base plate 364 has a hinge feature 364B. The hinge features 362B and 364B are cooperatively joined to form a hinge 366 between the base plates 362, 364. A biasing mechanism in the form a spring 367 (in some embodiments, an elastomeric spring) is mounted in the hinge 366 and tends to bias the base plates 362, 364 into a tilted or angled position as discussed below. The base plate 362 also includes stop features or tabs 362C (FIG. 22).

A first keypad 342 (e.g., a gaming keypad) is mounted on the first base plate 362. A second keypad 352 (e.g., a QWERTY text keypad) is mounted on the second base plate 364.

The coupling system 370 includes a frame 372 (FIG. 22) having a pair of opposed top and bottom rails 374. Each rail 374 has a longitudinally extending groove 376 and a lower control tab 378 (FIGS. 21 and 22). A guide slot 378A is defined in each control tab 378.

A control pin 380 is mounted in each slot 378A to slide therealong. A pair of opposed left side cams 382A and a pair of opposed right side cams 382B are secured to the undersides of the first base plate 362 and the second base plate 364, respectively. A pair of actuators 384 (FIG. 21; only one shown) are provided, each having a body 384A affixed to a respective one of the control pins 380 for movement therewith. Each actuator 384 further includes a plunger 384B braced against the hinge 366. The actuators 384 each have a biasing mechanism between the body 384A and the plunger 384B, such as a spring, tending to push the body 384A outwardly toward the adjacent rail 374.

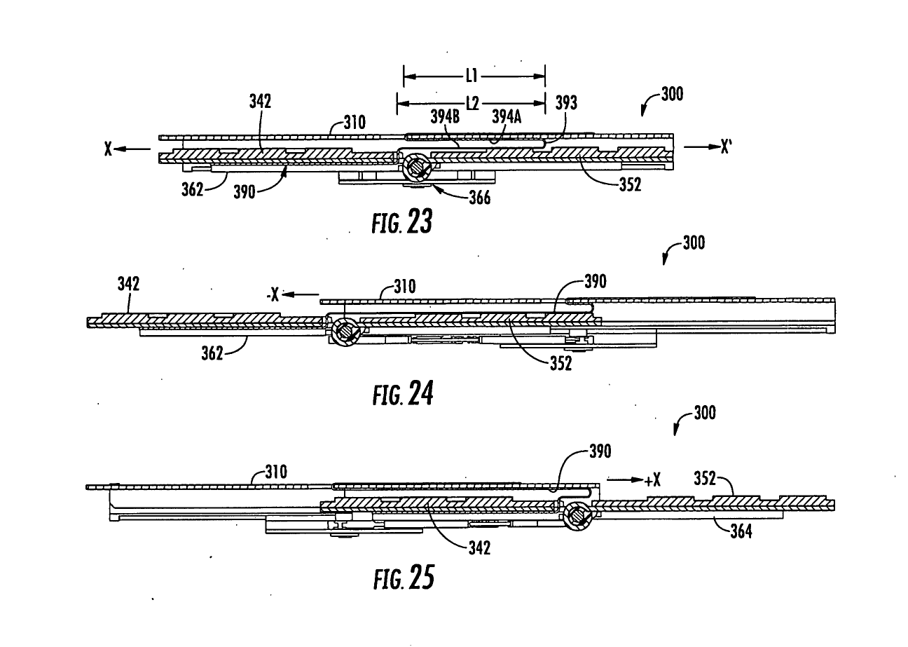

In the illustrated embodiment, a flexible printed circuit (FPC) connector 390 extends between the display unit 310 and the keypad unit 330 to provide a communications and/or data link between the units 310, 330. As shown in FIG. 23, in the closed position, the FPC connector 390 has a bend section 393, a first reserve section 394A, and a second reserve section 394B. The FPC connector 390 may be affixed to the base plate assembly 360 by adhesive 396A and to the display unit 310 by adhesive 394B.

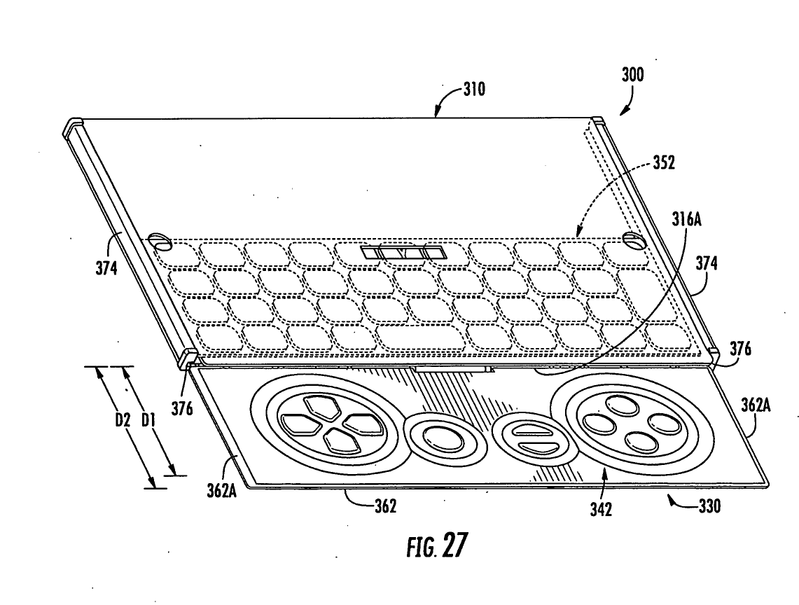

With reference to FIGS. 23-28, the terminal 300 may be used as follows. The terminal 300 may be placed in a closed position as shown in FIGS. 18-21 and 23 and corresponding to the closed position of the terminal 100. The terminal 300 can be placed in a first open position as shown in FIGS. 25 and 26 and corresponding to the first open position of the terminal 100 by sliding the keypad unit 330 in a first direction −X along a slide axis X-X. The terminal 300 can be placed in a second open position as shown in FIGS. 25 and 26 and corresponding to the second open position of the terminal 100 by sliding the keypad unit 330 in a second direction +X along the slide axis X-X. In the closed position, both of the keypads 342, 352 are substantially fully covered by the display unit 310. In the first open position, the first keypad 342 is exposed and the second keypad 352 remains substantially fully covered by the display unit 310. In the second open position, the second keypad 352 is exposed and the first keypad 342 remains substantially fully covered by the display unit 310.

The control pins 380, cams 382A, 382B and the actuators 384 may cooperate to provide more positive and stable positioning and the keypad unit 330. As the keypad 330 is displaced relative to the display unit 310 in the direction −X, the control pins 380 engage the cams 382B and, as a result, push the actuator bodies 384A progressively inwardly against the springs 384B until the control pins pass the apexes of the cams 382B. Likewise, as the keypad 330 is displaced relative to the display unit 310 in the direction +X, the control pins 380 engage the cams 382A and, as a result, push the actuator bodies 384A progressively inwardly against the springs 384B until the control pins 380 pass the apexes of the cams 382A. The control pins 380, cams 382A, 382B and actuators 384 thereby provide resistance against displacement from each of the prescribed closed, first open, and second open positions.

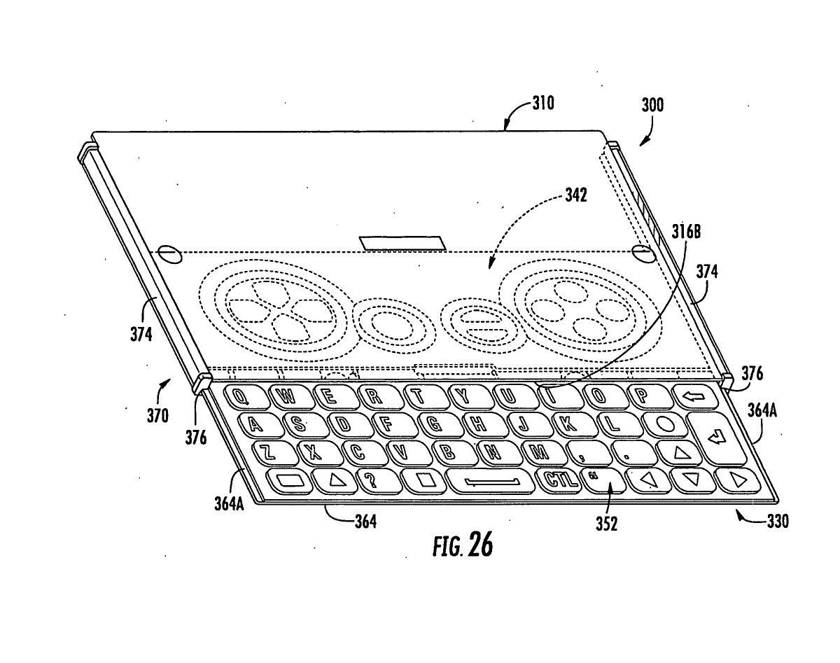

As shown in FIGS. 23-25, the configuration of the FPC connector 390 permits the base plate assembly 360 to be shifted into each of the three positions (i.e., closed, first open and second open) without binding or straining the FPC connector 390. As shown in FIG. 24, in the first open position, the first reserve section 394A is pulled down and extended to accommodate the stroke of the base plate assembly 360. As shown in FIG. 25, in the second open position, the second reserve section 394B is pulled up and extended to accommodate the stroke of the base plate assembly 360. According to some embodiments, the first reserve section 394A has a length L1 (FIG. 23), and the second reserve section 394B has a length L2 (FIG. 23) each of which may be from about 50% to 120% of the width of the display unit 310.

The coupling system 370 can be configured to selectively provide tilt or non-tilt between the display unit 310 and a deployed keypad 342, 352. For example, with reference to FIG. 26, the base plate 364 may be partially withdrawn from frame 372 such that the end portions of the edge portions 364A remain in the grooves 376. Thus, while the keypad 352 is now exposed and accessible for use by the operator, the keypad 352 remains fixed in a non-tilted orientation with respect to the display unit 310 and the display 314.

The base plate 362 may likewise be partially withdrawn (not shown) from frame 372 a first distance D1 (FIG. 27) such that the end portions of the edge portions 362A remain in the grooves 376. Thus, while the keypad 342 is now exposed and accessible for use by the operator, the keypad 342 remains fixed in a non-tilted orientation with respect to the display unit 310 and the display screen 314 (which may be referred to herein as a non-tilted first open position).

Alternatively, the base plate 362 may be fully withdrawn from frame 372 a second distance D2 (FIG. 27) greater than the first distance D1, such that the end portions of the edge portions 362A are fully freed from the grooves 376, as shown in FIG. 27. The frame 372 will then permit the base plate 362 to pivot about the hinge 366 relative to the base plate 364 to attain a tilted orientation (which may be referred to herein as a tilted first open position) as shown in FIG. 28. The bias of the spring 367 will then pull the base plates 362 and 364 into an angled or tilted orientation with respect to one another. The display unit 310 is mounted on the base plate 364 for movement therewith and thus will likewise be placed in an angled or tilted orientation with respect to the base plate 362. Thus, the keypad 352 is exposed and accessible for use by the operator, and is also placed in a tilted orientation with respect to the display unit 310 and the display screen 314. The tilting displacement between the base plates 362, 364 is enabled by the hinge 366. The degree of tilt (i.e., the tilt angle A2; FIG. 28) may be controlled by the configuration and prescribed relaxed position of the spring 367 and/or by a mechanical stop feature. According to some embodiments, the angle of tilt A2 is in the range of from about 90 to 180 degrees, according to some embodiments, between about 90 and 170 degrees, and, according to some embodiments between about 150 and 160 degrees.

When the operator wishes to return the keypad unit 330 to the closed position (or transition fully to the second open position), the operator can rotate the base plate 362 back into alignment with grooves 376, re-insert the edge portions 362A into the grooves 376, and push the base plate 362 back into the frame 372 to underlie the display unit 310. The stop tabs 362C can prevent or inhibit over rotation of the base plates 362, 364 and assist in aligning the base plate 362 with the grooves 376 by abutting the base plate 364 when the base plates 362, 364 are substantially coplanar.

The terminal 300 may be configured to also enable the base plate 364 to be fully withdrawn from the frame grooves 376 to provide a tilted open configuration (not shown) wherein the deployed and exposed keypad 352 is tilted with respect to the display unit 314 in the same manner as shown for the keypad 342 in FIG. 28.

While FPC connectors have been shown in certain embodiments, other types of power and/or data communications connectors may be used. For example, the display and keypad units may be connected by coaxial and/or fiber optic connectors.

Although embodiments according to the present invention are described with respect to handheld mobile terminals, the keypad deployment systems according to embodiments of the invention may be used in non-handheld mobile terminals. Furthermore, mobile terminals including keypad deployment systems according to embodiments of the invention may include mobile terminals not having wireless communications functionality or other features disclosed herein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. An electronic device comprising:
an upper display unit having a display screen thereon, the display unit having first and second opposed side edges;
a lower keypad unit having a first region and a second region and including a first keypad on the first region and a second keypad on the second region; and
a coupling system including:
a rail slot defined in one of the display unit and the keypad unit, the rail slot having first and second enlarged sections and a narrow section connecting the first and second enlarged sections; and
an outwardly extending guide post affixed to the other of the display unit and the keypad unit, the guide post including a head, the head having an outwardly biased latch member;
wherein the keypad unit is slidably connected to the display unit on a side opposite the display screen, the keypad unit being movable relative to the display unit along a slide axis between:
a closed position in which the display unit generally overlies the first keypad and the second keypad;
a first open position in which the first keypad is exposed and positioned adjacent the first side edge of the display unit; and
a second open position in which the second keypad is exposed and positioned adjacent the second side edge of the display unit;
wherein the guide post is slidably mounted in the rail slot such that the head is compressed when in the narrow section and expands when in the first or second enlarged section to thereby retain the keypad unit in the first or second open position.

2. The device of claim 1 wherein the display unit generally overlies the second keypad when the keypad unit is in the first open position, and the display unit generally overlies the first keypad when the keypad unit is in the second open position.

3. The device of claim 1 wherein the first keypad includes a set of control keys configured for controlling a video game.

4. The device of claim 3 wherein the second keypad includes a set of keys configured for entering text into the device.

5. The device of claim 4 wherein the second keypad is a QWERTY keypad.

6. The device of claim 1
wherein the guide post is configured to provide audible and/or tactile feedback as it expands in the first or second enlarged section.

7. The device of claim 1 including a flexible connector extending from the display unit to the keypad unit to provide a conduit for power and/or data transmission between the display unit and the keypad unit.

8. The device of claim 7 wherein the flexible connector includes a flexible printed circuit including at least one bend and at least one reserve section to accommodate movement of the keypad unit into each of the first and second open positions.

9. The device of claim 1 including a first wireless transmitter in the display unit and a second wireless transmitter in the keypad unit to enable data communications between the display unit and the keypad unit.

10. An electronic device comprising:
an upper display unit having a display screen thereon, the display unit having first and second opposed side edges; and
a lower keypad unit having a first region and a second region and including a first keypad on the first region and a second keypad on the second region;
wherein the keypad unit is slidably connected to the display unit on a side opposite the display screen, the keypad unit being movable relative to the display unit along a slide axis between:
a closed position in which the display unit generally overlies the first keypad and the second keypad;
a first open position in which the first keypad is exposed and positioned adjacent the first side edge of the display unit; and
a second open position in which the second keypad is exposed and positioned adjacent the second side edge of the display unit;
wherein the keypad unit is tilted at a tilt angle with respect to the display screen when the keypad unit is in at least one of the first and second open positions.

11. The device of claim 10 wherein the keypad unit is tilted at a tilt angle with respect to the display screen when the keypad unit is in each of the first and second open positions.

12. The device of claim 10 including a frame, wherein the keypad unit is slidably mounted in the frame, and the frame retains the first keypad in a non-tilted orientation with respect to the display screen when the keypad unit is withdrawn from the frame a first distance and permits the first keypad to attain a tilted orientation with respect to the display screen when the keypad unit it withdrawn from the frame a second distance.

13. The device of claim 12 wherein:
the first and second keypads are pivotally coupled to one another; and
the first keypad, when withdrawn from the frame the second distance, attains the tilted orientation with respect to the display screen by pivoting with respect to the second keypad.

14. The device of claim 13 including a spring configured to bias the first keypad to pivot with respect to the second keypad into the tilted orientation.

15. The device of claim 14 wherein the spring is an elastomeric spring.

16. (canceled)

17. (canceled)

18. An electronic device comprising:
a display unit including a display screen thereon and a frame, the display unit having first and second side edges; and
a keypad unit including a base member and a first keypad on the base member;
wherein the keypad unit is slidably mounted in the frame and movable along a slide axis between a closed position in which the display unit generally overlies the first keypad and a first open position in which the first keypad is exposed and positioned adjacent the first side edge of the display unit; and
wherein the frame retains the keypad in a non-tilted orientation with respect to the display screen when the keypad unit is withdrawn from the frame a first distance in a first direction along the slide axis and permits the keypad to attain a tilted orientation with respect to the display screen when the keypad unit is withdrawn from the frame a second distance in the first direction.

19. The device of claim 18 wherein:
the keypad unit includes first and second base members pivotally coupled to one another;
the first keypad is disposed on the first base member; and
the first keypad, when withdrawn from the frame the second distance in the first direction, attains the tilted orientation with respect to the display screen by pivoting with respect to the second base member.

20. The device of claim 19 including a spring configured to bias the first base member to pivot with respect to the second base member into the tilted orientation.

21. The device of claim 20 wherein the spring is an elastomeric spring.

22. The device of claim 19 including a second keypad disposed on the second base member, wherein the keypad unit is slidably mounted in the frame and movable along the slide axis between a closed position in which the display unit generally overlies the second keypad and a second open position in which the second keypad is exposed and positioned adjacent the second side edge of the display unit.

23. The device of claim 22 wherein the frame retains the second keypad in a non-tilted orientation with respect to the display screen when the keypad unit is withdrawn from the frame a first distance in a second direction along the slide axis that is opposite the first direction and permits the second keypad to attain a tilted orientation with respect to the display screen when the keypad unit is withdrawn from the frame a second distance in the second direction.
